(19) United States
(12) Patent Application Publication
(10) Pub. No.: US 2026/0027839 A1
(43) Pub. Date: Jan. 29, 2026

(54) EJECTION ABNORMALITY INSPECTION APPARATUS, INKJET RECORDING APPARATUS, EJECTION ABNORMALITY INSPECTION METHOD, AND STORAGE MEDIUM

(71) Applicant: Konica Minolta, Inc., Tokyo (JP)

(72) Inventor: Yasunori Inaba, Tokyo (JP)

(73) Assignee: Konica Minolta, Inc., Tokyo (JP)

(21) Appl. No.: 19/279,076

(22) Filed: Jul. 24, 2025

(30) Foreign Application Priority Data
Jul. 26, 2024 (JP) 2024-120723

(51) Int. Cl. B41J 2/21; B41J 2/045; B41J 3/44; G06K 15/02; H04N 1/00

(52) U.S. Cl. CPC B41J 2/2142; B41J 2/0451; B41J 2/04581; B41J 2/2135; B41J 2/2139; B41J 3/44; G06K 15/027; H04N 1/00795; G06K 2215/101; H04N 2201/0081

(57) ABSTRACT

An ejection abnormality inspection apparatus includes a hardware processor that is configured to determine whether there is an ejection bending nozzle in an inkjet head based on a number of deficient nozzles of the inkjet head acquired from a waveform of a residual vibration of a nozzle of the inkjet head and a number of white streaks acquired from read data of an image formed on a recording medium.

### CROSS-REFERENCE TO RELATED APPLICATION

The entire disclosure of Japanese Patent Application No. 2024-120723, filed on July 26, 2024, including description, claims, drawings and abstract is incorporated herein by reference.

### BACKGROUND OF THE INVENTION

### Technical Field

The present disclosure relates to an ejection abnormality inspection apparatus, an inkjet recording apparatus, an ejection abnormality inspection method, and a storage medium.

### Description of Related Art

Conventionally, there has been known an inkjet recording apparatus that records an image on a recording medium by ejecting ink from a nozzle of an inkjet head. In the inkjet recording apparatus, when a nozzle surface is damaged or a foreign substance adheres to the nozzle, a deviation occurs in an ejection angle of the nozzle. When the deviation of the ejection angle of the nozzle becomes equal to or more than a predetermined allowable value and the nozzle becomes an ejection bending nozzle, the ink is not formed at a place where the ink should be ejected, and thus a white streak occurs in the image. In addition, when the ink ejected from the ejection bending nozzle overlaps the ink ejected from another nozzle on the recording medium, a high-density streak (color streak) occurs in the image. Formation of such an abnormality streak in the image reduces image quality. Therefore, when the ejection bending nozzle occurs, it is necessary to accurately detect it.

Therefore, for example, Japanese Unexamined Patent Publication No. 2015-044308 describes an inkjet recording apparatus that detects the ejection bending nozzle by printing a chart image on the recording medium, reading the chart image with an image reading section, and detecting a density difference in the read image.

However, for example, in a case in which ink to be ejected is yellow ink, a density difference between a color streak and another area is small, and the color streak might not be able to be detected even if there is the ejection bending nozzle. Furthermore, the white streak may be generated not only by the ejection bending nozzle but also by a deficient nozzle that cannot eject any more ink. Therefore, in the invention of Japanese Unexamined Patent Publication No. 2015-044308, there is a risk that the occurrence of the ejection bending nozzle cannot be accurately sensed.

### SUMMARY OF THE INVENTION

The present disclosure has been made in view of such circumstances. It is an object of the present invention to provide an ejection abnormality inspection apparatus, an inkjet recording apparatus, an ejection abnormality inspection method, and a storage medium that can more accurately sense occurrence of an ejection bending nozzle.

In order to solve the above-described problem, according to one aspect of the present disclosure, an ejection abnormality inspection apparatus includes a hardware processor that is configured to determine whether there is an ejection bending nozzle in an inkjet head based on a number of deficient nozzles of the inkjet head acquired from a waveform of a residual vibration of a nozzle of the inkjet head and a number of white streaks acquired from read data of an image formed on a recording medium.

According to another aspect of the present disclosure, an inkjet recording apparatus includes:
an image former that forms an image on a recording medium by ejecting ink droplets from an inkjet head;
an image reader that acquires the read data by reading the image formed on the recording medium; and
the ejection abnormality inspection apparatus according to the previously described aspect.

According to another aspect of the present disclosure, an ejection abnormality inspection method of ejection bending by an inkjet recording apparatus including, an image former that forms an image on a recording medium by ejecting ink droplets from an inkjet head, and an image reader that reads the image formed on the recording medium, the ejection abnormality inspection method including:
determining whether there is an ejection bending nozzle in the inkjet head based on a number of deficient nozzles of the inkjet head acquired from a waveform of a residual vibration of a nozzle of the inkjet head and a number of white streaks from read data of the image formed on the recording medium.

According to another aspect of the present disclosure, a non-transitory computer-readable storage medium storing a program executed in a computer of an inkjet recording apparatus including, an image forming section that forms an image on a recording medium by ejecting ink droplets from an inkjet head, and an image reader that reads the image formed on the recording medium, the program causing the computer to perform,
determining whether there is an ejection bending nozzle in the inkjet head based on a number of deficient nozzles of the inkjet head acquired from a waveform of a residual vibration of a nozzle of the inkjet head and a number of white streaks from read data of the image formed on the recording medium.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a side view of an inkjet recording apparatus as viewed in a width direction;

FIG. 2 is a block diagram of essential parts of the inkjet recording apparatus;

FIG. 3 is a graph comparing a residual vibration waveform of a normal ejection nozzle and a residual vibration waveform of a deficient nozzle;

FIG. 4 is a graph comparing the residual vibration waveform of the normal ejection nozzle and the residual vibration waveform of the ejection bending nozzle;

FIG. 5 is an example of an image having an abnormality streak; and

FIG. 6 is a flowchart of ejection bending nozzle detection processing.

### DETAILED DESCRIPTION

Hereinafter, one or more embodiments of the present disclosure will be described with reference to the drawings. However, the scope of the invention is not limited to the disclosed embodiments.

Hereinafter, an inkjet recording apparatus including an ejection abnormality inspection apparatus according to an embodiment of the present disclosure will be described in detail with reference to the drawings. However, the scope of the invention is not limited to the illustrated examples. In the following description, components having the same function and configurations are denoted by the same reference numerals, and the description thereof will be omitted.

### Overall Configuration of Inkjet Recording Apparatus

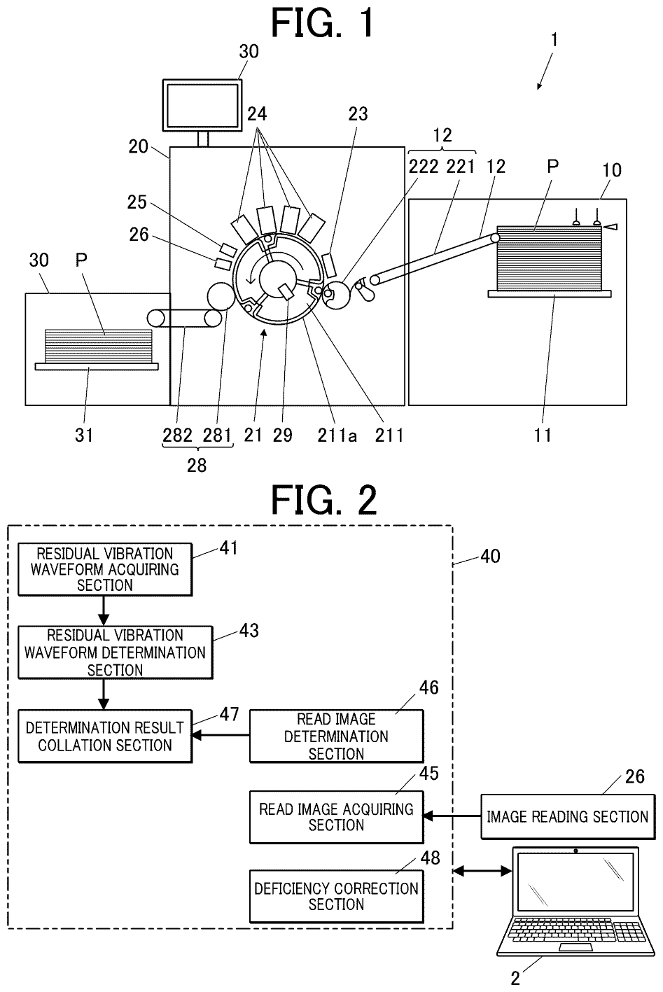

FIG. 1 is a cross-sectional side view showing a main configuration of an inkjet recording apparatus 1. FIG. 2 is a block diagram illustrating a functional configuration of part of the inkjet recording apparatus 1. The inkjet recording apparatus 1 includes a sheet feed section 10, an image forming section 20 (image former), a sheet ejection section 30, and a controller 40 (hardware processor).

### Sheet Feed Section

The sheet feed section 10 stores a recording medium P before image formation. The sheet feed section 10 conveys the recording medium P to the image forming section 20 under the control of the controller 40. The sheet feed section 10 includes a sheet feed tray 11 and a conveyance section 12.

### Sheet Feed Tray

The sheet feed tray 11 is a plate member that stores the recording medium P. The sheet feed tray 11 is provided such that one or a plurality of recording media P can be placed thereon. The sheet feed tray 11 is moved upward and downward according to an amount of the recording medium P placed thereon. By the upward and downward movements, the sheet feed tray 11 is kept such that an uppermost recording medium P is conveyed by the conveyance section 12.

### Conveyance Section

The conveyance section 12 conveys the recording medium P from the sheet feed tray 11 to the image forming section 20. The conveyance section 12 includes a conveyance mechanism. The conveyance mechanism drives a belt 123 to convey the recording medium P on the belt 123. The belt 123 has a ring shape, and an inner side of a ring is supported by a plurality of rollers 121 and 122.

The conveyance section 12 includes a supply section. The supply section delivers the uppermost recording medium P placed on the sheet feed tray 11 onto the belt 123. The conveyance section 12 conveys the recording medium P along the belt 123 by the supply section.

### Image Forming Section

The image forming section 20 performs a recording operation on the recording medium P under the control of the controller 40. The image forming section 20 includes an image forming drum 21, a handover unit 22, a sheet heating section 23, a head unit 24, an irradiation section 25, an image reading section 26 (image reader), and a delivery section 27.

### Image Forming Drum

The image forming drum 21 holds the recording medium P along its cylindrical outer periphery surface and the recording medium P is conveyed by the rotation of the image forming drum 21. The conveyance surface of the image forming drum 21 faces the sheet heating section 23, the head unit 24, and the irradiation section 25, and image formation processing is performed on the conveyed recording medium P.

### Handover Unit

The handover unit 22 is provided in a position between the conveyance section 12 and the image forming drum 21. The handover unit 22 includes a claw 221 and a handover drum 222.

The claw 221 is a cylindrical part that holds one end of the recording medium P conveyed by the conveyance section 12. The handover drum 222 guides the recording medium P held by the claw 221.

The handover unit 22 picks up the recording medium P on the conveyance section 12 with the claw 221 and places the recording medium P along the outer periphery surface of the handover drum 222. Thus, the handover unit 22 passes the recording medium P to the image forming drum 21.

### Sheet Heating Section

The sheet heating section 23 includes, for example, a heating wire and generates heat in response to energization. The sheet heating section 23 is controlled by the controller 40 to generate heat so that the recording medium P passing in the vicinity of the sheet heating section 23 has a predetermined temperature. The sheet heating section 23 is provided in a position in the vicinity of the outer periphery surface of the image forming drum 21 and on an upstream side of the head unit 24 in a conveyance direction of the recording medium P.

A temperature sensor (not illustrated) is provided near the sheet heating section 23. The controller 40 senses the temperature in the vicinity of the sheet heating section 23 with the temperature sensor. The controller 40 controls heat generation of the sheet heating section 23 based on the sensed temperature.

### Head Unit

The head unit 24 forms an image by ejecting ink onto a recording medium P based on, for example, a print job and image data received from an external device 2 described below. The head units 24 corresponding to the colors of C (cyan), M (magenta), Y (yellow), and K (black) are provided for each color. In FIG. 1, the head unit 24 corresponding to the colors of Y, M, C, and K are provided in this order from upstream of the conveyance direction of the recording medium P.

The head unit 24 of the present embodiment is configured such that a plurality of inkjet heads are arranged in a width direction on a carriage. Each inkjet head includes a tank for color ink, a channel, a piezoelectric element, a plurality of nozzles, and the like. The controller 40 causes a drive section, not illustrated, to apply a generated drive signal to displace (deform) the piezoelectric element, thereby applying pressure to the color ink supplied from the tank to the nozzle via the channel and causing the color ink to be ejected from the nozzle.

The head unit 24 forms an image by ejecting ink onto the recording medium P being conveyed, from the carriage whose length in the width direction is longer than the recording medium P. That is, the inkjet recording apparatus 1 is a line head type inkjet recording apparatus. The number of head units 24 provided in the image forming section 20 may be less than or equal to three or greater than or equal to five.

The ink ejected by the head unit 24 is, for example, ultraviolet curable ink. The ultraviolet curable ink is a gel-like ink that undergoes a phase change between a gel state and a liquid (sol) state according to the temperature when ultraviolet rays are not irradiated by the irradiation section 25. A sol-gel phase transition temperature of the ultraviolet curable ink is preferably in a range of 40 to 70° C. and more preferably in a range of 50 to 65° C.

### Irradiation Section

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided in the vicinity of the outer periphery surface of the image forming drum 21. The irradiation section 25 is positioned on a downstream side of the head unit 24 in the conveyance direction of the recording medium P. The irradiation section 25 emits the energy rays to the recording medium P on which the ink has been ejected. By the effect of the energy rays, the ink on the recording medium P is cured.

The fluorescent tube that emits ultraviolet rays is not limited to a low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet light with higher illuminance. The fluorescent tube is, for example, a light emission diode. The energy rays are not limited to the ultraviolet rays and may be the energy rays having a property of curing the ink depending on the property of the ink. The light source is determined depending on the energy rays.

Although the head unit 24 ejects the ultraviolet curable ink in the above description, the invention is not limited thereto. The ink ejected by the head unit 24 may be a water-based ink or other ink.

### Image Reading Section

The image reading section 26 is disposed on the downstream side of the irradiation section 25 in the conveyance direction so as to be able to read an image forming surface which is a surface of the recording medium P. The image reading section 26 is, for example, a line sensor or the like. The image reading section 26 reads the image forming surface of the recording medium P in a predetermined reading range, and transmits imaging data to a read image acquiring section 45, which will be described later, of the controller 40.

### Delivery Section

The delivery section 27 includes a conveyance mechanism. The conveyance mechanism conveys the recording medium P by driving a ring-shaped belt 273 whose inner side is supported by a plurality of rollers 271 and 272. The delivery section 27 includes a cylindrical handover roller 274. The handover roller 274 hands over the recording medium P from the image forming drum 21 to the conveyance mechanism. The delivery section 27 conveys the recording medium P passed onto the belt 273 by the handover roller 274, and sends the recording medium P to the sheet ejection section 30.

### Sheet Ejection Section

The recording medium P on which the image is formed by the image forming section 20 is ejected to the sheet ejection section 30.

The sheet ejection section 30 includes a plate-shaped sheet ejection tray 31. The recording medium P sent from the image forming section 20 by the delivery section 27 is placed on the sheet ejection tray 31. The sheet ejection section 30 stores the recording medium P until a user takes out the recording medium P.

### Controller

The controller 40 controls each unit constituting the inkjet recording apparatus 1. The controller 40 is connected to the various sections constituting the inkjet recording apparatus 1. The controller 40 includes a central processing unit (CPU), a random access memory (RAM), a read only memory (ROM), and the like.

The CPU reads various programs and data corresponding to processing contents from the storage device of the ROM or the like and executes them. The CPU controls the operation of each unit of the inkjet recording apparatus 1 according to the executed processing content. The RAM temporarily stores various programs, data, and the like to be processed by the CPU. The ROM is a nonvolatile storage device such as a hard disk drive (HDD), a solid state drive (SSD), or a flash memory, and stores various programs, data, and the like read by the CPU or the like.

The controller 40 (hardware processor) functions as a residual vibration waveform acquiring section 41, a residual vibration waveform determination section 43, a read image acquiring section 45, a read image determination section 46, a determination result collation section 47, and a deficiency correction section 48 by cooperation of the CPU, the RAM, and the ROM. Among these, the controller 40 functions as an ejection abnormality inspection apparatus by at least the residual vibration waveform acquiring section 41, the residual vibration waveform determination section 43, the read image acquiring section 45, and the determination result collation section 47.

### Residual Vibration Waveform Acquiring Section

The residual vibration waveform acquiring section 41 detects a residual vibration after an ink ejection and acquires a residual vibration waveform which is a waveform of the residual vibration. As described above, when a drive waveform is applied to the piezoelectric element, the piezoelectric element is deformed, the pressure is applied to the ink, and the ink is ejected from the nozzle. At this time, the residual pressure vibration is generated in the ink and is propagated to the piezoelectric element, and a residual vibration voltage is induced. The residual vibration waveform acquiring section 41 senses the residual vibration voltage and transmits the waveform to the residual vibration waveform determination section 43.

### Residual Vibration Waveform Determination Section

The residual vibration waveform determination section 43 compares the residual vibration waveform acquired from the residual vibration waveform acquiring section 41 with the residual vibration waveform of the normal ejection nozzle stored in the ROM or the like in advance, thereby determining whether or not the nozzle of which the residual vibration waveform is acquired by the residual vibration waveform acquiring section 41 is the deficient nozzle. Through the processing, the residual vibration waveform determination section 43 acquires the number of deficient nozzles. Note that the deficient nozzle refers to the nozzle that is no longer able to eject the ink (an ejection deficiency occurs) due to clogging caused by adhesion and fixing of the ink to the nozzle, for example. In addition, by the above-described processing, the residual vibration waveform determination section 43 functions as an identifying section that specifies whether or not any of the nozzles is the deficient nozzle.

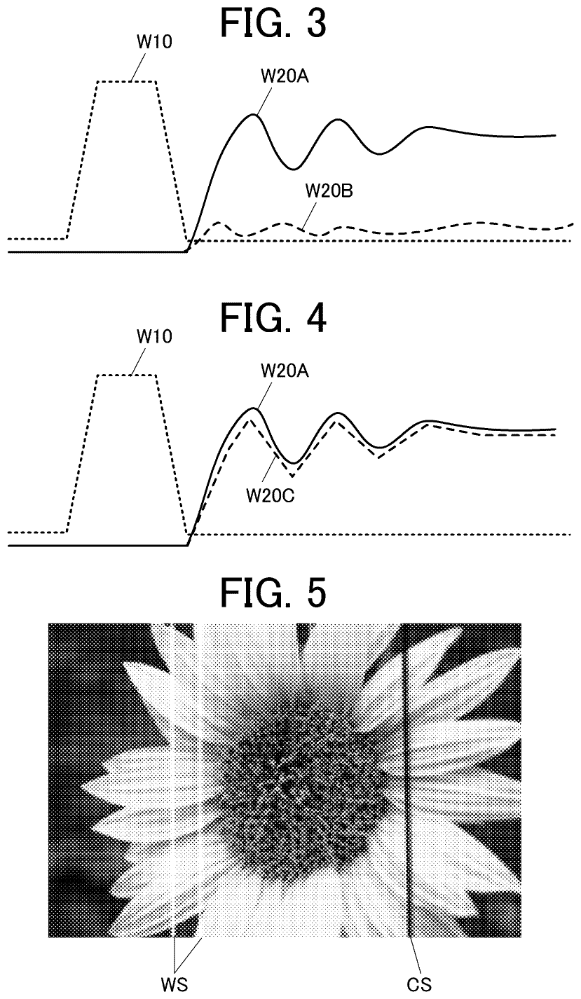

FIG. 3 shows a diagram in which the drive waveforms and the residual vibration waveforms of the

deficient nozzle and the normal ejection nozzle are arranged. In FIG. 3, a horizontal axis represents time and a vertical axis represents voltage. In addition, in FIG. 3, W10 represents the drive waveform, W20A represents the residual vibration waveform of the normal ejection nozzle, and W20B represents the residual vibration waveform of the deficient nozzle. As illustrated in FIG. 3, the residual vibration waveform of the deficient nozzle and the residual vibration waveform of the normal ejection nozzle have a large difference in amplitude. Therefore, the residual vibration waveform determination section 43 can detect the deficient nozzle by acquiring the residual vibration waveform from the nozzle.

In addition, FIG. 4 illustrates a diagram in which the drive waveforms and the residual vibration waveforms of the nozzle (ejection bending nozzle) in which a deviation occurs in the ejection angle of the ink due to a flaw on the nozzle surface or adhesion of a foreign substance to the nozzle and a normal ejection nozzle are arranged. In FIG. 4, W20C illustrates the residual vibration waveform of the ejection bending nozzle. As illustrated in FIG. 4, a difference between the residual vibration waveforms of the ejection bending nozzle and the normal ejection nozzle is slight. Therefore, it is difficult to detect the ejection bending nozzle based on the residual vibration waveform.

### Read Image Acquiring Section

The read image acquiring section 45 acquires read data of the image formed on the recording medium P from the image reading section 26.

### Read Image Determination Section

The read image determination section 46 acquires the number of white streaks WS by comparing the read data acquired by the read image acquiring section 45 with, for example, image data.

FIG. 5 illustrates an example in which read data having an abnormality streak is emphasized. As shown in FIG. 5, there are two types of abnormality streaks, the white streak WS and a color streak CS. The white streak WS is formed because the ink is not ejected from the nozzle which should eject the ink to the relevant area. That is, the white streak WS is formed by both of the ejection bending nozzle and the deficient nozzle. On the other hand, the color streak CS is formed due to the ink being ejected from the nozzle that should not eject the ink to the relevant area. That is, the color streak CS is formed by the ejection bending nozzle only.

### Determination Result Collation Section

The determination result collation section 47 is a determination section which collates a determination result of the residual vibration waveform determination section 43 with the determination result of the read image determination section 46 to determine the presence or absence of the deficient nozzle and the ejection bending nozzle and the number thereof.

In detail, as described above, the determination result collation section 47 can acquire the presence or absence of the deficient nozzle and the number thereof from the determination result of the residual vibration waveform determination section 43. In addition, the determination result collation section 47 can determine the presence or absence of the ejection bending nozzles and the number thereof by comparing the determination result of the residual vibration waveform determination section 43 and the determination result of the read image determination section 46.

More specifically, the determination result collation section 47 compares the number of deficient nozzles acquired from the residual vibration waveform determination section 43 with the number of white streaks WS acquired from the read image determination section 46 when acquiring the presence or absence of the ejection bending nozzles and the number thereof. As described above, the white streak WS is formed by both the ejection bending nozzle and the deficient nozzle. Therefore, in a case where the number of white streaks WS acquired from the read image determination section 46 is the same as the number of deficient nozzles acquired from the residual vibration waveform determination section 43, the determination result collation section 47 can determine that all of the white streaks WS are formed by deficient nozzles and that there is no ejection bending nozzle. On the other hand, when the number of white streaks WS acquired from the read image determination section 46 is greater than the number of deficient nozzles acquired from the residual vibration waveform determination section 43, the determination result collation section 47 can determine that the difference between the two is the number of ejection bending nozzles.

### Deficiency Correction Section

In a case in which the deficient nozzle is sensed, the deficiency correction section 48 performs deficiency correction processing for preventing the occurrence of an image defect (the occurrence of the white streak WS) due to the deficient nozzle. The deficiency correction processing is processing to complement the image data by, for example, adjusting the amount of ink ejected from the nozzles in the vicinity of the deficient nozzle or adjusting the position of ejection.

### Notification Section

The notification section 50 notifies various kinds of information under the control of the controller 40. In FIG. 1, a case in which the notification section 50 is a display part having a screen is illustrated, but the present invention is not limited thereto. The notification section 50 may be a speaker that emits sound, a communication section that can communicate with another device via a predetermined network, or the like.

### External Device

The external device 2 is a device separate from the inkjet recording apparatus 1. The external device 2 supplies a print job, image data, and the like to the controller 40.

### Ejection Bending Nozzle Detection Processing

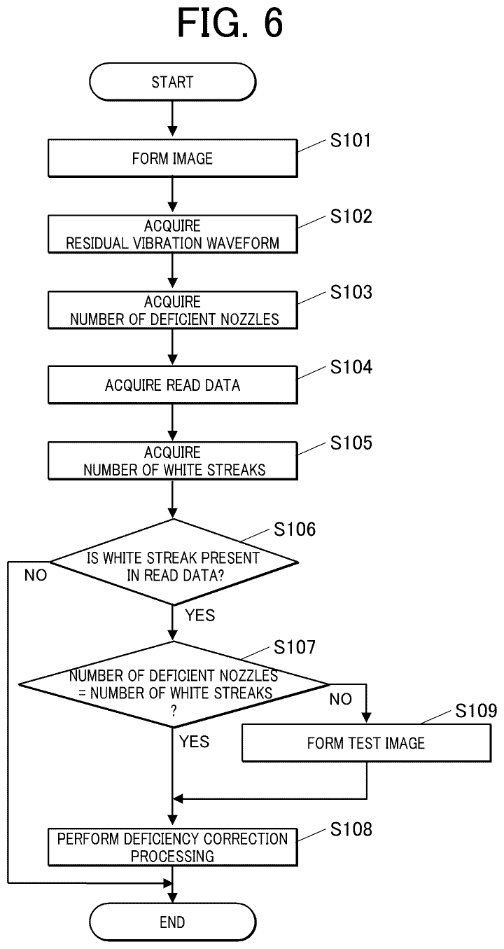

The ejection bending nozzle detection processing in such inkjet recording apparatus I will be described with reference to the flowchart of FIG. 6.

Upon receipt of a print job and the image data from the external device 2, the controller 40 drives the head unit 24 to form the image on the recording medium P (step S101).

The residual vibration waveform acquiring section 41 acquires the residual vibration waveform from each of the nozzles after the image formation, and transmits the residual vibration waveform to the residual vibration waveform determination section 43 (step S102). The residual vibration waveform determination section 43 acquires the number of deficient nozzles based on the acquired residual vibration waveform (step S103).

When the recording medium P on which the image has been formed passes through the image reading section 26, the read image acquiring section 45 acquires the read data (step S104). The read image determination section 46 acquires the number of white streaks WS by comparing the read data and the image data (step S105).

The read image determination section 46 determines the presence or absence of the white streak WS (step S106). In a case where there is no white streak WS (step S106: No), an abnormality nozzle does not occur. Therefore, the controller 40 ends the ejection bending nozzle detection processing.

In a case where the white streak WS is present (step S106: Yes), the abnormality nozzle is generated. Therefore, the determination result collation section 47 acquires a breakdown of the abnormality nozzle by acquiring the determination results from the residual vibration waveform determination section 43 and the read image determination section 46.

The determination result collation section 47 determines whether or not the number of deficient nozzles acquired by the residual vibration waveform determination section 43 in step S103 is the same as the number of white streaks WS acquired by the read image determination section 46 in step S105 (step S107). In a case where the number of deficient nozzles and the number of white streaks WS are the same (step S107: Yes), all of the abnormal nozzles are the deficient nozzles. Therefore, the deficiency correction section 48 performs the above-described deficiency correction processing on the deficient nozzle from which the residual vibration waveform is acquired (step S108). The presence of the deficient nozzle is notified to the user by the notification section 50, and the ejection bending nozzle detection process ends.

In a case where the number of the deficient nozzles and the number of the white streaks are different from each other (step S107; No), that is, in a case where the number of the white streaks WS is larger than the number of the deficient nozzles, the difference shows the ejection bending nozzles that are generated. The controller 40 can specify whether any of the nozzles is the deficient nozzle from an acquisition source of the residual vibration waveform, but cannot specify whether any of the nozzles is the ejection bending nozzle. Therefore, the controller 40 causes the head unit 24 to form the test image, thereby identifying which of the nozzles is the ejection bending nozzle (step S109).

The controller 40 that has identified which of the nozzles is the ejection bending nozzle masks the ejection bending nozzle, and then proceeds to step S108 and causes the deficiency correction section 48 to perform deficiency correction processing in the same manner as for the deficient nozzle. Next, the notification section 50 notifies the user of the presence of the deficient nozzle and the ejection bending nozzle, and the ejection bending nozzle detection processing ends.

### Effects of Embodiment

As described above, according to the present embodiment, the determination result collation section 47 functions as a determination section which determines the presence or absence of the ejection bending nozzles from the number of deficient nozzles acquired from the waveform of the residual vibration of the nozzles of the inkjet head and the number of white streaks WS acquired from the read data of the image. According to the configuration, even in a case where the color streak CS does not have a detectable density, since the color streak CS is not used in sensing the occurrence of the ejection bending nozzle, it is possible to more accurately sense the occurrence of the ejection bending nozzle.

Further, as described above, the controller 40 can execute the ejection abnormality inspection process while forming the job image by the normal image formation processing. Therefore, in a case where there is no ejection bending nozzle, it is not necessary to perform special processing, and the productivity of image formation does not decrease.

### Other Configurations

Although specific description has been given above based on the embodiments according to the present disclosure, the present disclosure is not limited to the above-described embodiments. It is needless to say that the present disclosure can be subjected to various modifications including the scope of the invention described in the scope of the claims and the scope of equivalents thereof.

For example, in the above description, the configuration in which the print job and the image data are received from the external device 2 has been exemplified, but the present invention is not limited thereto. For example, the inkjet recording apparatus 1 may include a known operation input section, a scanner, or the like, and the print job and the image data may be directly input by the user.

In addition, in the above description, a case where the inkjet recording apparatus 1 includes the image forming section 20 of the line head type is exemplified, but the invention is not limited thereto. The image forming section 20 may be of a serial head type in which a carriage 242, whose length in a width direction is shorter than that of the recording medium P, scans in the width direction to form the image. In the above-described configuration, the abnormality streak in the width direction may be formed.

Furthermore, although the residual vibration waveform of the deficient nozzle and the residual vibration waveform of the normal ejection nozzle are greatly different in amplitude in the description above, it is not limited thereto. The residual vibration waveform of the deficient nozzle and the residual vibration waveform of the normal ejection nozzle may have greatly different cycles of amplitude.

Further, in the above description, the residual vibration waveform is acquired during the image formation, but the present invention is not limited thereto. For example, the residual vibration waveform may be acquired by applying a minute voltage that does not cause ejection of an ink droplet from the nozzle in a sheet interval of the recording medium P.

In addition, in the above description, a configuration in which the controller 40 of the inkjet recording apparatus 1 functions as the ejection abnormality inspection apparatus is exemplified, but the invention is not limited thereto. That is, a PC or the like separate from the inkjet recording apparatus 1 may function as the ejection abnormality inspection apparatus by functioning as the residual vibration waveform acquiring section 41, the residual vibration waveform determination section 43, the read image acquiring section 45, the read image determination section 46, and the determination result collation section 47.

Furthermore, although an example in which a hard disk, a semiconductor nonvolatile memory, or the like used as a ROM is used as a computer-readable medium of the program according to the present disclosure has been disclosed above, it is not limited to this example. As another computer-readable medium, a portable recording medium such as a CD-ROM can be applied. Furthermore, a carrier wave is also applied as a medium for providing data of the program according to the present disclosure via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An ejection abnormality inspection apparatus comprising:
a hardware processor that is configured to determine whether there is an ejection bending nozzle in an inkjet head based on a number of deficient nozzles of the inkjet head acquired from a waveform of a residual vibration of a nozzle of the inkjet head and a number of white streaks acquired from read data of an image formed on a recording medium.

2. The ejection abnormality inspection apparatus according to claim 1, wherein the hardware processor is configured to determine that there is no ejection bending nozzle in a case in which the number of deficient nozzles and the number of white streaks are the same, and determines that there is the ejection bending nozzle in a case in which the number of deficient nozzles and the number of white streaks are different.

3. The ejection abnormality inspection apparatus according to claim 2, wherein the hardware processor is configured to determine that there is the ejection bending nozzle in a case in which the number of the white streaks is greater than the number of the deficient nozzles.

4. The ejection abnormality inspection apparatus according to claim 1, wherein the hardware processor is configured to identify whether any of the nozzles is the deficient nozzle or the ejection bending nozzle.

5. The ejection abnormality inspection apparatus according to claim 4, wherein, in a case in which the hardware processor determines that there is the ejection bending nozzle, the hardware processor is configured to form a test image, and identify which of the nozzles is the ejection bending nozzle.

6. The ejection abnormality inspection apparatus according to claim 1, wherein the image is a job image.

7. An inkjet recording apparatus comprising:
an image former that forms an image on a recording medium by ejecting ink droplets from an inkjet head;
an image reader that acquires the read data by reading the image formed on the recording medium; and the ejection abnormality inspection apparatus according to claim 1.

8. The inkjet recording apparatus according to claim 7, wherein the hardware processor is configured to perform a deficiency correction of the deficient nozzle in a case in which the hardware processor determines that there is no ejection bending nozzle.

9. An ejection abnormality inspection method of ejection bending by an inkjet recording apparatus including, an image former that forms an image on a recording medium by ejecting ink droplets from an inkjet head, and an image reader that reads the image formed on the recording medium, the ejection abnormality inspection method comprising:
determining whether there is an ejection bending nozzle in the inkjet head based on a number of deficient nozzles of the inkjet head acquired from a waveform of a residual vibration of a nozzle of the inkjet head and a number of white streaks from read data of the image formed on the recording medium.

10. A non-transitory computer-readable storage medium storing a program executed in a computer of an inkjet recording apparatus including, an image forming section that forms an image on a recording medium by ejecting ink droplets from an inkjet head, and an image reader that reads the image formed on the recording medium, the program causing the computer to perform,
determining whether there is an ejection bending nozzle in the inkjet head based on a number of deficient nozzles of the inkjet head acquired from a waveform of a residual vibration of a nozzle of the inkjet head and a number of white streaks from read data of the image formed on the recording medium.
